(19) United States
(12) Patent Application Publication
(10) Pub. No.: US 2017/0253466 A1
(43) Pub. Date: Sep. 7, 2017

(54) HOIST TOOL FOR HANDLING A SHRINK ELEMENT OF A GEAR SYSTEM

(71) Applicant: Moventas Gears Oy, Jyvaskyla (FI)

(72) Inventor: Casey FREEMAN, Hillsboro, OR (US)

(73) Assignee: Moventas Gears Oy, Jyvaskyla (FI)

(21) Appl. No.: 15/061,396

(22) Filed: Mar. 4, 2016

(51) Int. Cl. B66C 19/00; F03D 1/00; B66C 5/02; F03D 80/50

(52) U.S. Cl. CPC B66C 19/005; F03D 80/50; F03D 1/003; B66C 5/025; B66C 9/14

(57) ABSTRACT

A hoist tool for handling a shrink element of a gear system. The hoist tool includes a suspension section, support legs for leaning on a foundation structure of the gear system and for supporting the suspension section to be above the shrink element, a lift sling for surrounding the shrink element, and a force generating system between the suspension section and the lift sling and suitable for generating a lifting force on the lift sling so as to suspend the shrink element. During maintenance of the gear system, the weight of the shrink element can be compensated for with the hoist tool and therefore crane capacity is needed for compensating for only the rest of the weight of the gear system without the weight of the shrink element.

### FIELD OF THE DISCLOSURE

The disclosure relates generally to maintenance of a gear system. More particularly, the disclosure relates to a hoist tool for handling a shrink element of a gear system, the shrink element being designed for pressing a hollow shaft radially against an inner shaft a part of which is inside the hollow shaft. Furthermore, the disclosure relates to a method for handling a shrink element of a gear system during maintenance work.

### BACKGROUND

In many cases a gear system comprises a gear module, a first rotating coupling between the gear module and a first external system, and a second rotating coupling between the gear module and a second external system. The gear module may comprise for example one or more planetary gear stages and/or one or more spur gear stages. The first external system can be for example a wind turbine and the second external system can be for example a generator. In wind power applications of the kind mentioned above, the rotating coupling between the wind turbine and the gear module may be such that the shaft of the gear module is hollow and an end-section of the shaft of the wind turbine is inside the hollow shaft. The rotating coupling comprises a shrink element configured surround the hollow shaft of the gear module and to press the hollow shaft radially against the end section of the shaft of the wind turbine so as to enable torque transfer from the wind turbine to the gear module.

Maintenance of a gear system comprises often, or at least sometimes, moving one or more gear stages and/or other elements in the axial direction so that appropriate elements can be removed from the gear system and/or so that access to appropriate elements of the gear system can be provided for maintenance personnel. For example, there can be a need to remove the above-mentioned shrink element and/or a gear ring of a planetary gear stage in order to achieve a situation where the weight of the remaining gear system is less than the maximum available crane capacity. An inherent challenge related to maintenance work that comprises moving one or more gear stages and/or other elements in the axial direction is a need for crane capacity for compensating for a sufficient portion of the weight of the gear system during the axial movement.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the present invention, there is provided a new hoist tool for handling a shrink element of a gear system where the shrink element is suitable for pressing a hollow shaft radially against an inner shaft a part of which is inside the hollow shaft. A hoist tool according to the invention comprises:
a suspension section,
support legs for leaning on a foundation structure of the gear system and for supporting the suspension section to be above the shrink element,
a lift sling for surrounding the shrink element, and
a force generating system connected between the suspension section and the lift sling and suitable for generating lifting force on the lift sling so as to suspend the shrink element.

The weight of the above-mentioned shrink element can be compensated for with the aid of the hoist tool and therefore no crane capacity is needed for compensating for the weight of the shrink element. In many cases it may be advantageous to suspend the gear system so that the weight of the shrink element is compensated for with the aid of the hoist tool and the rest of the weight of the gear system, e.g. the weight of a gear module, is wholly or partially compensated for with a crane for example when the gear system or a part of it is moved axially at the operating site of the gear system. The operating site can be e.g. a nacelle of a wind power plant. As the shrink element can be suspended by the hoist tool, the above-mentioned crane can be kept attached to the rest of the gear system and therefore in many cases there is no need to use the crane for handling the shrink element. Furthermore, in many cases, a hoist tool of the kind described above can be used as an alignment tool during installation or reinstallation of a gear system.

A hoist tool according to an exemplifying and non-limiting embodiment of the invention further comprises a spacer element that is suitable for being placed on the above-mentioned inner shaft and suitable for keeping the shrink element concentric with respect to the inner shaft in a situation in which the hollow shaft is absent from a room between the shrink element and the inner shaft.

In accordance with the present invention, there is provided also a new method for handling a shrink element of a gear system during maintenance work. A method according to the invention comprises at least the following actions at an operating site of the gear system:
installing a tool so that the tool has a physical contact with the shrink element and becomes capable of suspending the shrink element, and
directing, to the shrink element, lifting force with the aid of the tool so as to at least partly compensate for the weight of the shrink element.

The above-mentioned tool can be for example a hoist tool according to the invention. It is however also possible that the tool is e.g. a cradle or a support structure with sliders for supporting the shrink element when the tool is under the shrink element.

The operating site of the gear system where the above-mentioned method is carried out can be, for example but not necessarily, a nacelle of a wind power plant.

A number of exemplifying and non-limiting embodiments of the invention are described in accompanied dependent claims.

Various exemplifying and non-limiting, embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

Exemplifying and non-limiting embodiments of the invention and their advantages are explained in greater detail below in the sense of examples and with reference to the accompanying drawings, in which:

FIG. 1a shows a section view of a part of a gear system according to the prior art,

FIG. 1b illustrates an exemplifying situation in which a hoist tool according to an exemplifying and non-limiting embodiment of the invention has been arranged to suspend the shrink element of the gear system shown in FIG. 1a,

FIGS. 2a and 2b illustrate a hoist tool according to another exemplifying and non-limiting embodiment of the invention,

FIGS. 3a-3c illustrate a way of using a hoist tool according to an exemplifying and non-limiting embodiment of the invention, and

FIG. 4 shows a flowchart of a method according to an exemplifying and non-limiting embodiment of the invention for handling a shrink element of a gear system during maintenance work.

### DESCRIPTION OF EXEMPLIFYING AND NON-LIMITING EMBODIMENTS

The specific examples provided in the description below should not be construed as limiting the scope and/or the applicability of the accompanied claims. Lists and groups of examples provided in the description are not exhaustive unless otherwise explicitly stated.

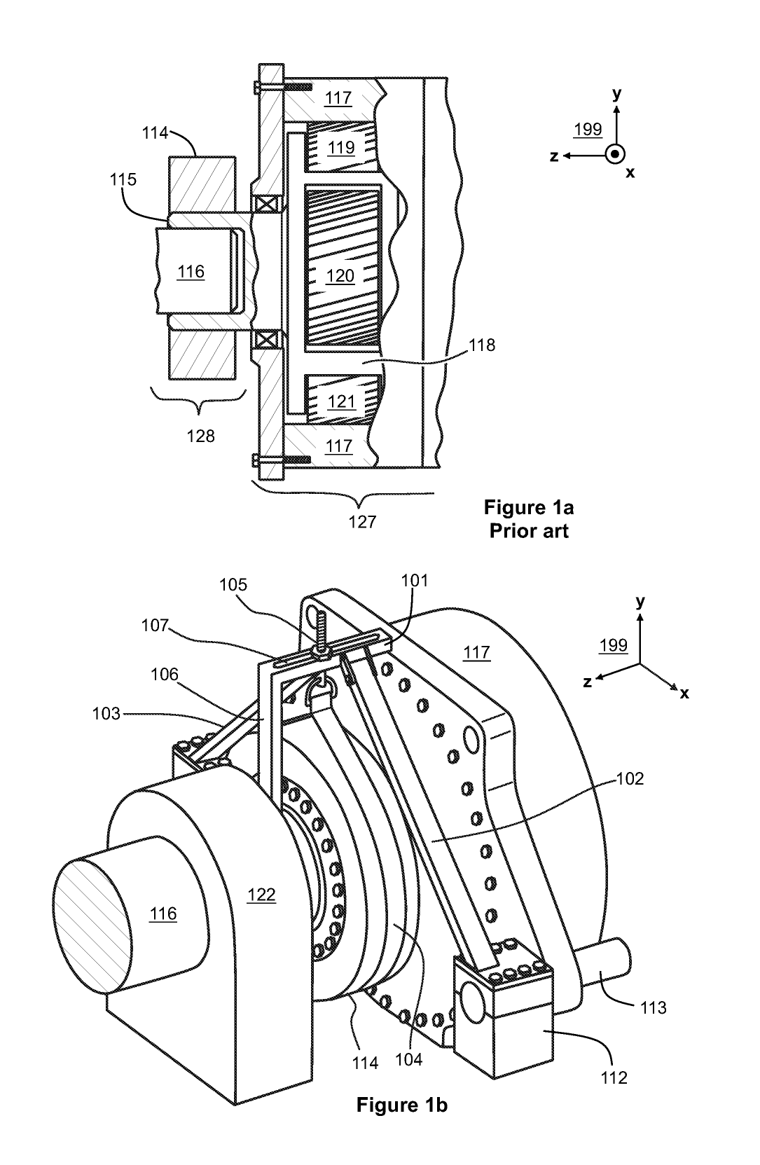

FIG. 1a shows a section view of a part of a gear system according to the prior art. The section plane is parallel with the yz-plane of a coordinate system 199. The gear system comprises a gear module 127 that comprises at least one gear stage. The gear system comprises a rotating coupling 128 for connecting the gear module to a shaft 116 of an external system. The external system can be for example a wind turbine and the shaft 116 can be the main shaft of the wind turbine. In the exemplifying case illustrated in FIG. 1a, the gear module 127 comprises a planetary gear stage which comprises a gear ring 117, a planet carrier 118, and planet wheels. In FIG. 1a, three of the planet wheels are denoted with references 119, 120, and 121. A hollow shaft 115 is connected to the planet carrier 118 as illustrated in FIG. 1a. The rotating coupling 128 comprises a shrink element 114 configured surround the hollow shaft 115 and to press the hollow shaft radially against the end-section of the shaft 116 so as to enable torque transfer between the shaft 116 and the hollow shaft 115. It is worth noting that the gear system illustrated in FIG. 1a is presented for illustrative purposes only in order to explain hoist tools according to exemplifying and non-limiting embodiments of the invention. Furthermore, it is worth noting that hoist tools according to exemplifying and non-limiting embodiments of the invention can be used in conjunction with gear systems different from the gear system illustrated in FIG. 1a.

FIG. 1b illustrates the gear system shown in FIG. 1a in a case where a hoist tool according to an exemplifying and non-limiting embodiment of the invention has been arranged to suspend the shrink element 114 of the gear system. In the exemplifying situation shown in FIG. 1b, the shaft 116 is supported with a shaft clamp 122 so that the shaft 116 does not substantially direct forces to the gear system. The hoist tool comprises a suspension section 101 and support legs 102 and 103. As illustrated in FIG. 1b, the support legs 102 and 103 are suitable for leaning on a foundation structure of the gear system so that the suspension section 101 is above the shrink element 114. In this exemplifying case, the hoist tool further comprises a support rod 106 for leaning on the shaft 116 and for supporting the suspension section 101 to be above the shrink element 114. It is, however, also possible that a hoist tool according to another exemplifying and non-limiting embodiment of the invention comprises such support legs for leaning on a foundation structures that there is no need for a support rod for leaning on a shaft. In FIG. 1b, a part of the foundation structure of the gear system is denoted with a reference 112. The gear module is supported to the foundation structure with the aid of dowel pins one of which is denoted with a reference 113 in FIG. 1b. The hoist tool comprises a lift sling 104 for surrounding the shrink element 114. The hoist tool comprises a force generating system 105 connected between the suspension section 101 and the lift sling 104. The force generating system 105 is suitable for generating lifting force on the lift sling 104 so as to suspend the shrink element 114. In the situation shown in FIG. 1b, the lifting force is in the positive y-direction of the coordinate system 199.

In the exemplifying hoist tool illustrated in FIG. 1b, the force generating system 105 comprises a threaded rod and a nut for generating the lifting force on the lift sling 104 so as to suspend the shrink element 114. It is also possible that a force generating system of a hoist tool according to another exemplifying and non-limiting embodiment of the invention comprises a hydraulic cylinder and a corresponding piston, a chain hoist, or some other suitable force generating means. The suspension section 101 is configured to allow the force generating system 105 to be moved in the axial direction of the shafts 115 and 116 so as to enable the shrink element 114 to be moved in the axial direction when the shrink element 114 is being suspended by the lift sling 104. In FIGS. 1a and 1b, the axial direction is parallel with the z-direction of the coordinate system 199. In the exemplifying hoist tool illustrated in FIG. 1b, the suspension section 101 comprises an elongated slit 107 whose edges are configured to mechanically support the force generating system 105 so that the force generating system is moveable in the axial direction. The suspension section 101 and/or the force generating system 105 can be provided with friction reduction means such as for example Teflon sliders or tracks provided with rollers. The friction reduction means are not shown in FIG. 1b.

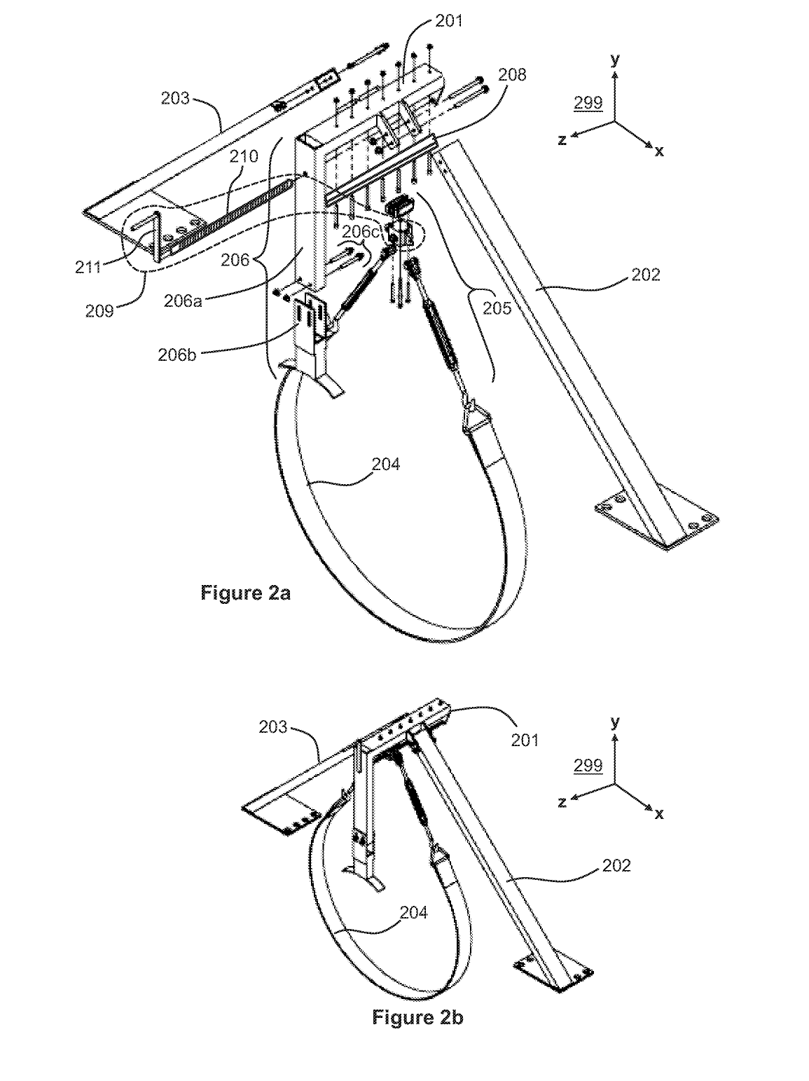

FIG. 2a shows an exploded view of a hoist tool according to an exemplifying and non-limiting embodiment of the invention. FIG. 2b shows the hoist tool as assembled. The hoist tool comprises a suspension section 201 and support legs 202 and 203. The support legs 202 and 203 are suitable for leaning on a foundation structure of a gear system in the same way as illustrated in FIG. 1b. The hoist tool further comprises a support rod 206 that is suitable for leaning on a shaft in the same way as illustrated in FIG. 1b. The support rod comprises two portions 206a and 206b and fastening elements 206c. The fastening elements 206c are suitable for fastening the two portions 206a and 206b on each other so that the length of the support rod 206 is changeable by changing the mutual position of the two portions of the support rod 206. In this exemplifying case, the fastening elements 206c comprise bolts and nuts.

The hoist tool comprises a lift sling 204 for surrounding a shrink element of a gear system in the same way as illustrated in FIG. 1b. The hoist tool comprises a force generating system 205 connected between the suspension section 201 and the lift sling 204. The force generating system 205 is suitable for generating lifting force on the lift sling 204 in the y-direction of a coordinate system 299. In the exemplifying hoist tool illustrated in FIGS. 2a and 2b, the force generating system 205 comprises two turnbuckles and corresponding turnbuckle screws for generating the lifting force on the lift sling 204.

The suspension section 201 of the hoist tool is configured to allow the force generating system 205 to be moved in directions parallel with the z-axis of the coordinate system 299 so as to enable a shrink element of a gear system to be moved in its axial direction when the shrink element is suspended by the lift sling 204. In this exemplifying hoist tool, the suspension section 201 comprises a guide rail 208 for mechanically supporting the force generating system 205 so that the force generating system is moveable in the directions parallel with the z-axis of the coordinate system 299. The suspension section further comprises a drive system 209 for moving the force generating system 205 in the directions parallel with the z-axis of the coordinate system 299. In this exemplifying case, the drive system 209 comprises a rotatable threaded rod 210 for moving the force generating system 205 in the directions parallel with the z-axis of the coordinate system 299. The drive system 209 comprises further comprises a crank 211 for rotating the rotatable threaded rod 210.

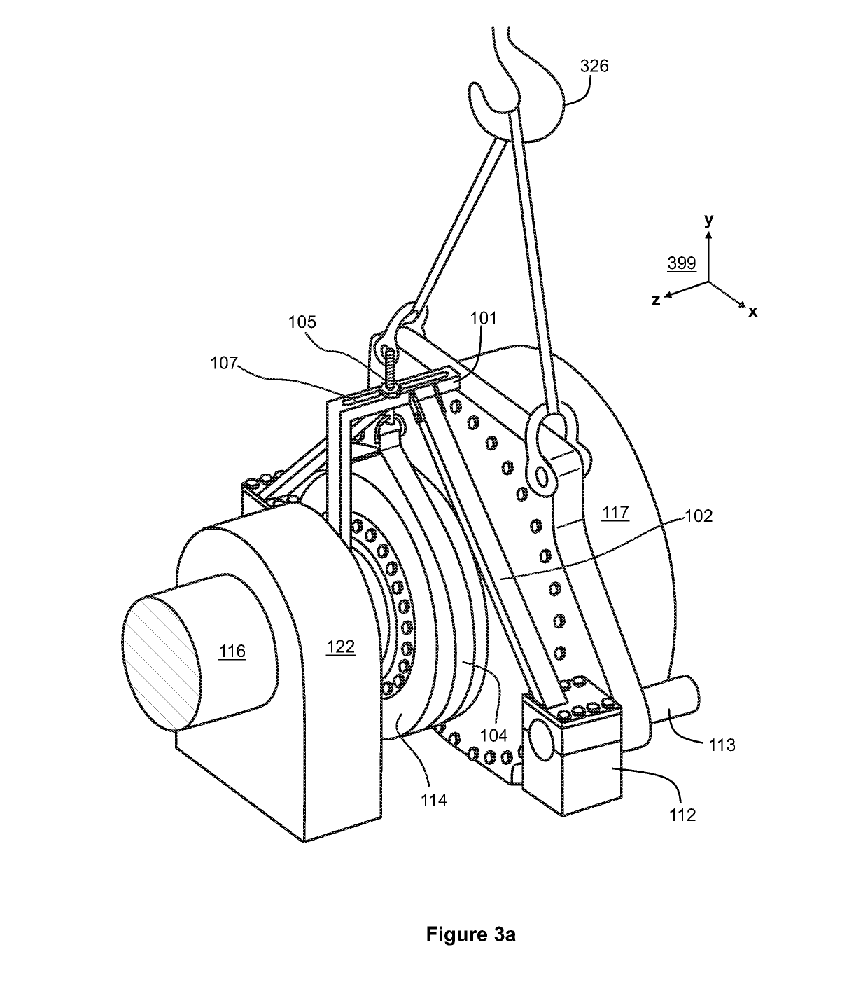

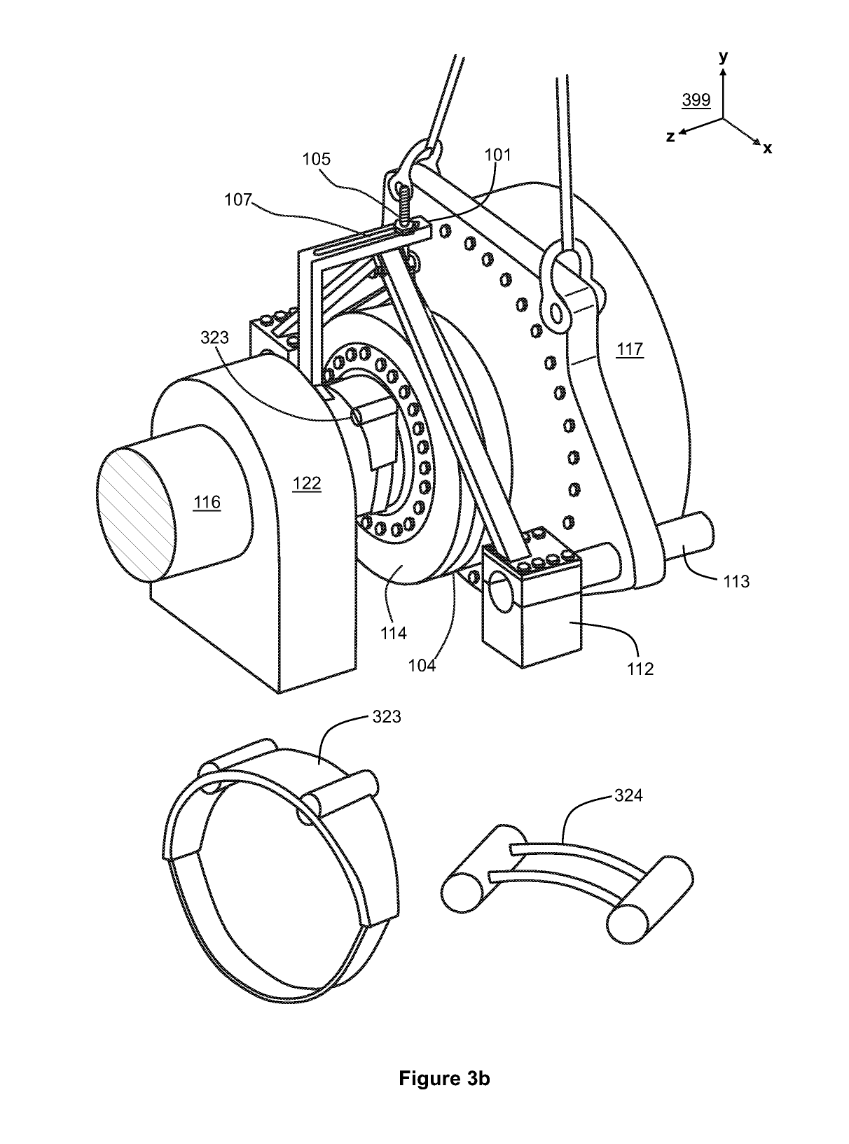

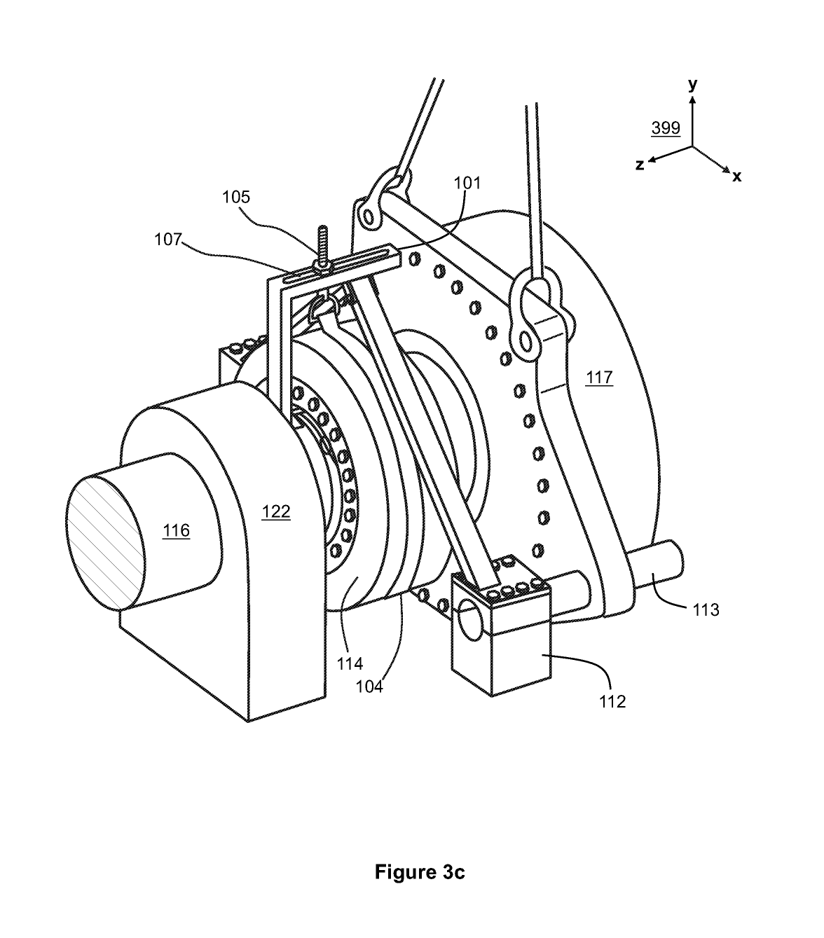

FIGS. 3a, 3b, and 3c illustrate a way of using a hoist tool according to an exemplifying and non-limiting embodiment of the invention. In this exemplifying case, the hoist tool is similar to the hoist tool described above with reference to FIG. 1b. FIG. 3a shows a situation in which a shaft clamp 122 has been installed so that a shaft 116 does not substantially direct forces to a gear system under maintenance work. Furthermore, the hoist tool has been arranged to suspend a shrink element 114 and a crane has been arranged to suspend a gear module of the gear system. In FIG. 3a, the hook of the crane is denoted with a reference 326. The shrink element 114 is loosened and the lift sling 104 of the hoist tool is hoisted until the shrink element 114 does not direct substantive force to the shaft of the gear module. Thereafter, the shrink element 114 and the gear module are moved in the negative z-direction of a coordinate system 399. FIG. 3b shows a situation in which the shrink element 114 and the gear module have been moved in the negative z-direction of the coordinate system 399. In this exemplifying case, the hoist tool comprises a spacer element 323 that is suitable for being placed on the shaft 116 as illustrated in FIG. 3b. FIG. 3b shows also a magnified view of the spacer element 323 and an exemplifying alternative spacer element 324. After the spacer element 323 has been placed on the shaft 116, the shrink element 114 is moved in the positive z-direction of the coordinate system 399 so that the spacer element 323 gets between the shrink element 114 and the shaft 116. The purpose of the spacer element 323 is to keep the shrink element 114 concentric with respect to the shaft 116. The spacer element 323 may comprise low friction materials such as for example Teflon and/or Delrin. FIG. 3c shows a situation in which the shrink element 114 has been moved in the positive z-direction of the coordinate system 399. Thereafter, the dowel pins can be removed and the gear module can be lifted away with the crane so that the shrink element 114 is not involved, i.e. there no need to lift the shrink element together with the gear module.

In conjunction with certain gear systems, there is a need to arrange a situation of the kind illustrated in FIG. 3b in order to have access to all bolts which are fastening the gear ring 117. After the bolts have been removed, the gear ring 117 can be removed and lifted away. Thereafter, the dowel pins can be removed and the gear module without the gear ring 117 can be lifted away with the crane. In FIGS. 3a-3c, one of the dowel pins is denoted with the reference 113. If the hoist tool is removed, the shrink element 114 can be lifted away together with the gear module from which the gear ring 117 has been removed earlier. Alternatively, the shrink element 114 can be moved in the positive z-direction so that the situation illustrated in FIG. 3c takes place and thereafter the gear module without the gear ring 117 can be lifted away so that the shrink element 114 is not involved.

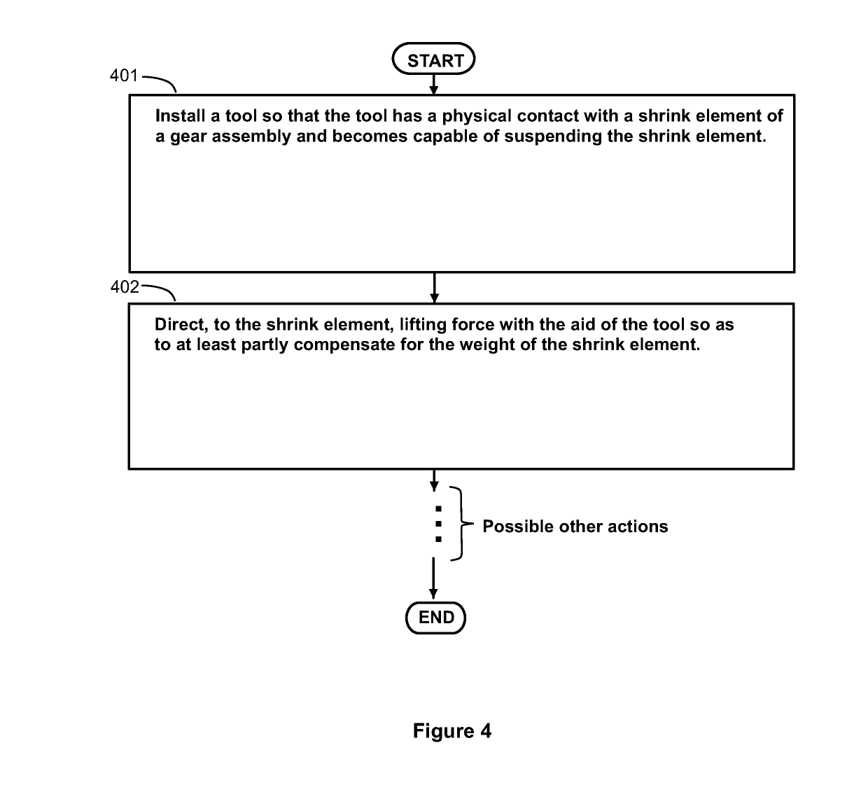

FIG. 4 shows a flowchart of a method according to an exemplifying and non-limiting embodiment of the invention for handling a shrink element of a gear system during maintenance work. The shrink element is designed for pressing a hollow shaft radially against an inner shaft a part of which is inside the hollow shaft so as to enable torque transfer between the hollow shaft and the inner shaft. The gear system may comprise for example one or more planetary gear stages and/or one or more spur gear stages.

The method comprises at least the following actions at an operating site of the gear system:
action 401: installing a tool so that the tool has a physical contact with the shrink element and becomes capable of suspending the above-mentioned shrink element, and
action 402: directing, to the shrink element, lifting force with the aid of the tool so as to at least partly compensate for the weight of the shrink element.

The above-mentioned tool can be for example a hoist tool such as described above with reference to FIG. 1b or to FIGS. 2a and 2b. It is also possible that the tool is e.g. a cradle or a support structure with sliders for supporting the shrink element when the tool is under the shrink element.

In a method according to an exemplifying and non-limiting embodiment of the invention, the gear system is a part of a wind power plant and the operating site of the gear system is the nacelle of the wind power plant.

In a method according to an exemplifying and non-limiting embodiment of the invention, the possible other actions mentioned in FIG. 4 comprise:
placing a spacer element on the above-mentioned inner shaft, and
sliding the shrink element in an axial direction of the hollow shaft onto the spacer element so that the shrink element is moved away from a position where the shrink element surrounds the hollow shaft, the spacer element keeping the shrink element concentric with respect to the inner shaft when the shrink element is on the spacer element.

The specific examples provided in the description given above should not be construed as limiting the scope and/or the applicability of the accompanied claims. Lists and groups of examples provided in the description given above are not exhaustive unless otherwise explicitly stated.

What is claimed is:

1. A hoist tool for handling a shrink element of a gear system, the shrink element being designed for pressing a hollow shaft radially against an inner shaft, the hoist tool comprising:
a suspension section,
support legs for leaning on a foundation structure of the gear system and for supporting the suspension section to be above the shrink element,
a lift sling for surrounding the shrink element, and
a force generating system connected between the suspension section and the lift sling and suitable for generating lifting force on the lift sling so as to suspend the shrink element.

2. A hoist tool according to claim 1, wherein the hoist tool further comprises a spacer element suitable for being placed on the inner shaft and for keeping the shrink element concentric with respect to the inner shaft in a situation in which the hollow shaft is absent from a room between the shrink element and the inner shaft.

3. A hoist tool according to claim 1, wherein the force generating system comprises a threaded rod and a nut for generating the lifting force on the lift sling so as to suspend the shrink element.

4. A hoist tool according to claim 1, wherein the force generating system comprises one or more turnbuckles and turnbuckle screws for generating the lifting force on the lift sling so as to suspend the shrink element.

5. A hoist tool according to claim 1, wherein the hoist tool further comprises a support rod for leaning on the inner shaft and for supporting the suspension section to be above the shrink element.

6. A hoist tool according to claim 5, wherein the support rod comprises two portions and fastening elements for fastening the two portions on each other so that a length of the support rod is changeable by changing a mutual position of the two portions.

7. A hoist tool according to claim 1, wherein the suspension section is configured to allow the force generating system to be moved in an axial direction of the hollow shaft so as to enable the shrink element to be moved in the axial direction when the shrink element is suspended by the lift sling.

8. A hoist tool according to claim 7, wherein the suspension section comprises an elongated slit whose edges are configured to mechanically support the force generating system so that the force generating system is moveable in the axial direction.

9. A hoist tool according to claim 7, wherein the suspension section comprises a guide rail for mechanically supporting the force generating system so that the force generating system is moveable in the axial direction.

10. A hoist tool according to claim 7, wherein the suspension section comprises a drive system for moving the force generating system in the axial direction.

11. A hoist tool according to claim 10, wherein the drive system comprises a rotatable threaded rod for moving the force generating system in the axial direction in response to rotation of the rotatable threaded rod.

12. A hoist tool according to claim 11, wherein the drive system comprises a crank for rotating the rotatable threaded rod.

13. A method for handling a shrink element of a gear system during maintenance work, the shrink element being designed for pressing a hollow shaft radially against an inner shaft, the method comprising at least the following actions at an operating site of the gear system:
installing a tool so that the tool has a physical contact with the shrink element and becomes capable of suspending the shrink element, and
directing, to the shrink element, lifting force with the aid of the tool so as to at least partly compensate for weight of the shrink element.

14. A method according to claim 13, wherein the tool is a hoist tool that comprises:
a suspension section,
support legs for leaning on a foundation structure of the gear system and for supporting the suspension section to be above the shrink element,
a lift sling for surrounding the shrink element, and
a force generating system connected between the suspension section and the lift sling and suitable for generating the lifting force so as to at least partly compensate for the weight of the shrink element.

15. A method according to claim 13, wherein the method comprises placing a spacer element on the inner shaft and sliding the shrink element in an axial direction of the hollow shaft onto the spacer element so that the shrink element is moved away from a position where the shrink element surrounds the hollow shaft, the spacer element keeping the shrink element concentric with respect to the inner shaft when the shrink element is on the spacer element.

16. A method according to claim 14, wherein the method comprises placing a spacer element on the inner shaft and sliding the shrink element in an axial direction of the hollow shaft onto the spacer element so that the shrink element is moved away from a position where the shrink element surrounds the hollow shaft, the spacer element keeping the shrink element concentric with respect to the inner shaft when the shrink element is on the spacer element.

17. A method according to claim 13, wherein the gear system is a part of a wind power plant and the operating site of the gear system is a nacelle of the wind power plant.

18. A method according to claim 14, wherein the gear system is a part of a wind power plant and the operating site of the gear system is a nacelle of the wind power plant.

19. A method according to claim 15, wherein the gear system is a part of a wind power plant and the operating site of the gear system is a nacelle of the wind power plant.

20. A method according to claim 16, wherein the gear system is a part of a wind power plant and the operating site of the gear system is a nacelle of the wind power plant.
